(19) United States
(12) Patent Application Publication
(10) Pub. No.: US 2025/0030287 A1
(43) Pub. Date: Jan. 23, 2025

(54) A ROTOR WITH EMBEDDED MAGNETS FOR A PERMANENT MAGNET MOTOR

(71) Applicant: DACS A/S, Nørre Snede (DK)

(72) Inventors: Jens Dybdahl, Ejstrupholm (DK); Peter Omand Rasmussen, Nørresundby (DK); Simon Staal Nielsen, Aalborg (DK); Mihai Stati, Horsens (DK)

(73) Assignee: DACS A/S, Nørre Snede (DK)

(21) Appl. No.: 18/709,133

(22) PCT Filed: Nov. 8, 2022
(86) PCT No.: PCT/EP2022/081116

§ 371 Date: May 10, 2024

(30) Foreign Application Priority Data
Nov. 12, 2021 (DK) PA 2021 70555

(51) Int. Cl. H02K 1/276; H02K 7/14

(52) U.S. Cl. CPC H02K 1/276; H02K 7/14; H02K 2213/03

(57) ABSTRACT

A rotor for a permanent motor includes a cylindrical rotor body, a plurality of magnet slots, wherein a circumference of each of the magnet slots, in a plane perpendicular to the rotor axis, has a specific shape, wherein the specific shape comprises a first portion, a second portion and a narrowing between the first and second portions. The rotor comprises a plurality of magnets extending along the length of each of the magnet slots, where the magnets are positioned within the first portion and separated from the second portion by the narrowing, wherein a pair of adjacent magnet slots are configured so that they taper towards a radius of the rotor body, and so that the magnets in a pair of the magnet slots form a magnetic pole.

### CROSS-REFERENCE TO RELATED APPLICATIONS

This application is the U.S. National Stage of PCT/EP2022/081116 filed on Nov. 8, 2022, which claims priority to Denmark Patent Application PA 2021 70555 filed on Nov. 12, 2021, the entire content of both are incorporated herein by reference in their entirety.

### FIELD OF THE INVENTION

The invention relates to permanent magnet motors.

### BACKGROUND OF THE INVENTION

EP 3 261 220 B1 discloses an electric machine for a vehicle, comprising a stator, and a rotor comprising a plurality of poles, where each pole comprises a first V-shaped flux barrier and a second V-shaped flux barrier, where the first flux barrier comprises two magnets with inner air cavities and outer air cavities, where the second flux barrier comprises two magnets with inner air cavities and outer air cavities, and where the flux barriers are arranged adjacent each other and symmetrically to the d-axis, where the pole comprises a first V-shaped flux redirector arranged symmetrically to the d-axis and between the first flux barrier and the second flux barrier.

In order to design a motor with improved characteristics such as improved efficiency, less complex design, smaller rotor diameter the inventors have devised the present invention.

### SUMMARY OF THE INVENTION

It is an object of the invention to provide an improved permanent motor which achieves one or more of the above mentioned objectives.

In a first aspect of the invention there is provided a motor rotor comprising
a cylindrical rotor body defining a rotor axis, wherein the cylindrical rotor body has a diameter in the range from 50 to 100 mm, such as in the range from 60 to 80 mm
a plurality of magnet slots extending axially through the rotor body, wherein
a circumference of each of the magnet slots, in a plane perpendicular to the rotor axis, has a specific shape, wherein
the specific shape extends from a first radial position proximal to an outer circumference of the rotor body to a second radial position distal to the outer circumference, and
the specific shape comprises a first portion, a second portion, and a narrowing between the first and second portions,
a plurality of magnets extending along the length of each of the magnet slots, where the magnets are positioned within the first portion and separated from the second portion by the narrowing, wherein
a pair of adjacent magnet slots are oriented so that lines connecting the first and second radial positions of the respective slots taper towards a radius of the rotor body, and
the magnets in the pair of the magnet slots form a magnetic pole.

Advantageously, the maximum diameter of 100 mm of the rotor body enables use of the motor in applications where a small diameter is required. At the same time, the rotor design has shown to provide excellent torque generation and efficiency. As such, efficiencies above 90%, such as 93% is achievable.

The length of the rotor body, i.e. the length in the axial direction, may in the range from 80 to 200 mm, such as in the range from 90 to 150 mm, such as in the range from 105 to 130 mm.

The angle θ between the pair of lines 330a, 330b connecting the first and second radial positions 311, 312 of the pair of shapes 310 of the magnet slots 210 is in the range from 40 to 50 degrees such as around 45 degrees. Accordingly, pairs of magnets in the corresponding pair of magnet slots form a V-shaped figure, with the apex of the V-shaped figure pointing towards the rotor axis.

The second portion of the specific shape of the magnet slots tapers towards the rotor axis. Thus, the second portion may have the shape of a triangle with the apex of the triangle pointing towards a center area of the rotor body.

Specifically, the second portion of the specific shape of one of the magnet slots of the pair of adjacent magnet slots comprises a straight extension parallel with a radial direction of the rotor body and parallel with a corresponding straight extension of the specific shape of the second portion of the other of the magnet slots of the pair of adjacent magnet slots.

According to an embodiment, an air gap is formed between a side of each of the magnets being closest to the outer circumference of the rotor body and a side of each of the magnet slots being closest to the outer circumference of the rotor body.

The number of poles corresponding to the number of pairs of magnet slots is in the range from 10 to 18, such as in the range from 12 to 16, such as 14.

A second aspect of the invention relates to a permanent magnet motor comprising the motor rotor according to any of the first aspect and a stator. The stator comprises coils such as concentrated coils arranged according to know principles to generate electromagnetic poles.

A third aspect of the invention relates to a fan comprising
a motor comprising a stator and the motor rotor according to the first aspect,
an impeller, wherein a rotation axis of the impeller is coaxial with the rotor axis.

The impeller of the fan may have a diameter in the range from 600 to 1700 mm.

The small diameter of the rotor, e.g. a diameter in the range from 60 to 80 mm, plus the radial extension of the stator, implies that the radius of the motor can be made small as compared with the fan diameter so that the motor's disturbance of the air flow is minimized.

In summary the invention relates to a rotor for a permanent motor. The rotor body comprises cylindrical holes, i.e. slots, extending axially through the rotor body wherein circumference of the cylindrical holes has a specific shape. The specific shape extends from a first radial position proximal to an outer circumference of the rotor body to a second radial position distal to the outer circumference. The specific shape comprises a first portion, a second portion, and a narrowing between the first and second portions. Magnets are positioned within the first portion and separated from the second portion by the narrowing. A pair of adjacent cylindrical holes are oriented so that lines connecting the first and second radial positions form a V-shape. Thus, a pair of adjacent magnet slots are configured the magnets in a pair of the magnet slots forms a magnetic pole and so that the long dimension of the rectangular magnets in a plane perpendicular to the rotor axis taper towards the radius of the rotor body.

In general, the various aspects and embodiments of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a permanent magnet motor;

FIG. 2 shows a rotor of the permanent magnet motor;

FIG. 3 shows a cross-sectional view of the rotor body;

FIG. 4 shows a pair of magnet slots with magnets inserted; and

FIG. 5 shows a fan driven by the permanent motor.

### DETAILED DESCRIPTION OF EMBODIMENTS

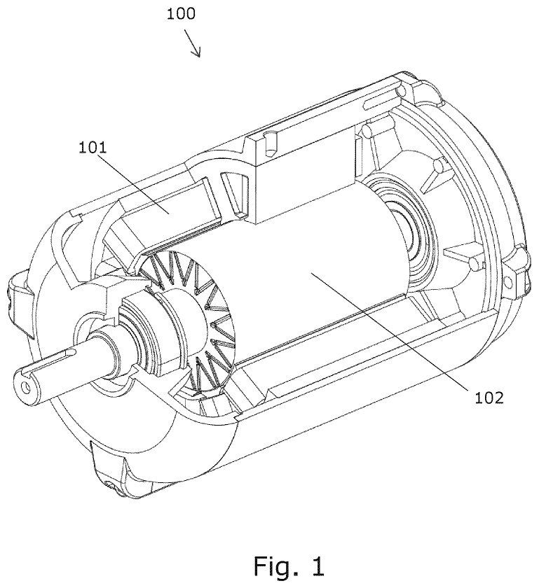

FIG. 1 shows a permanent magnet motor 100 comprising a stator 101 and a rotor 102.

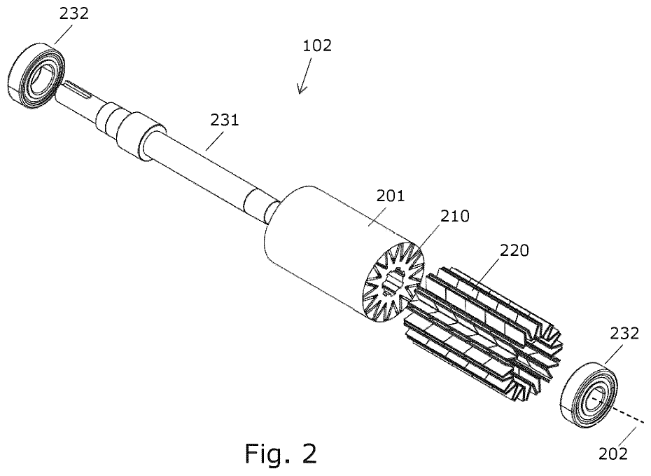

FIG. 2 shows the rotor 102 in an exploded view. The rotor 102 comprises a cylindrical rotor body 201 defining a rotor axis 202. The cylindrical rotor body 201 has a circular cross-section in a plane perpendicular to the rotor axis 202. The rotor body is preferably made from laminated steel, but could also be made from other materials. The diameter is of the rotor is the range from 50 to 100 mm, such as in the range from 60 to 80 mm. In an example, the diameter is approximately 70 mm, for example 70.5 mm.

The rotor body 201 is also referred to as a rotor stack.

As illustrated, a plurality of magnet slots 210 is formed in the rotor body 201 so that each slot 210 extends axially through the rotor body parallel with the rotor axis 202. Accordingly, the slots 210 are cylindrical through-holes.

A cylindrical hole is defined in that the ends of the hole form congruent parallel bases. The bases can have any other circumference. The bases are connected by a 3D surface formed by the surface resulting from the outer circumference of the bases when any of them is translated along a straight line to the other base.

Each of the magnet slots 210 contains a plurality of magnets arranged adjacent to each other and extending along the length of the slot and along the rotor axis 202. Preferably, the length of the extension of the plurality of magnets along the rotor axis 202 is equal or substantially equal to the axial length of rotor. Accordingly, the magnets in a magnet slot may be arranged adjacent to each other from one circular face of the rotor body to the opposite face of the rotor body. The axial length of the rotor body is in the range from 80 to 200 mm, such as in the range from 90 to 150 mm, preferably in the range from 105 to 130 mm. For example, the rotor body 201 may have a length of approximately 114 mm and made from e.g. 325 laminations or other number of laminations depending on the lamination thickness and rotor length.

FIG. 2 shows how the magnets 220 are arranged in rows of adjacent magnets when they are positioned in the magnet slots 210.

The rotor shaft 231 is supported in each end, external to the rotor body 201, by ball bearings 232.

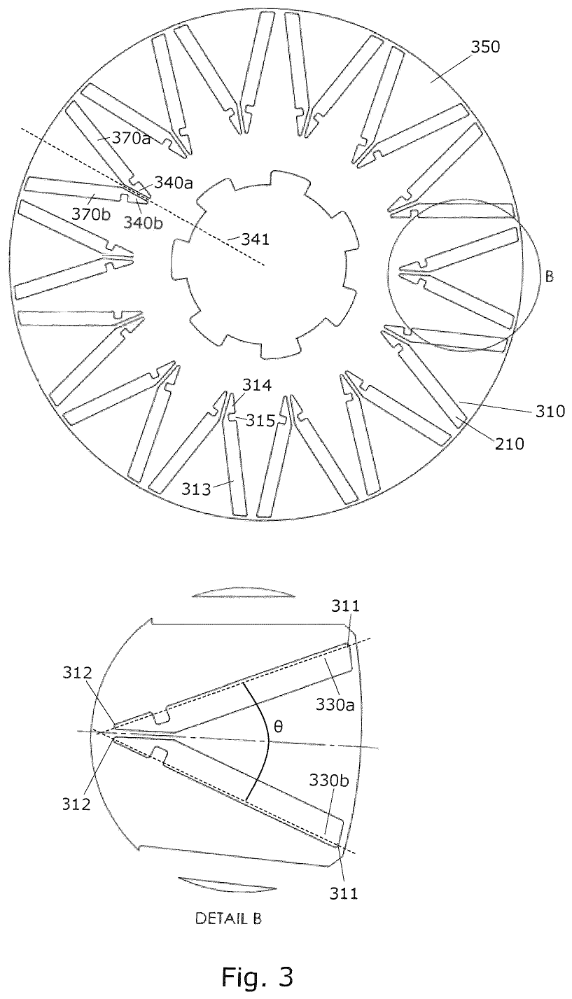

FIG. 3 shows a cross-sectional view of the rotor body 201 in a plane perpendicular to the rotor axis 202.

The cross-sectional view shows the specific shape 310 of the circumference of each of the magnet slots 210. Thus, the specific shape 310 is the shape or form of the cross-section of the slot 210 in a plane perpendicular to the rotor axis 202.

The specific shape extends from a first radial position 311 proximal to the outer circumference of the rotor body 201 to a second radial position 312 distal to the outer circumference, i.e. closer to the rotor axis. Thus, the first radial position 311 represents a point of the cross-sectional circumference of the magnet slot closest to the outer circumference of the rotor body 201 and the second radial position 312 represents a point of the circumference of the slot closest to rotor axis 202 of the rotor body.

The material thickness between the first radial position 311 and the outer circumference of the rotor body may in the range from 0.4 to 1 mm, e.g. approximately 0.8 mm.

The specific shape 310 comprises a first portion 313 for accommodating the magnets 220, a second portion 314 which is empty, i.e. filled with air and therefore generates a high magnetic reluctance and a narrowing 315 between the first and second portions.

The narrowings 315 are also referred to as magnet posts.

The first portion 313 has a general rectangular shape and extends from near the outer cylindrical surface of the rotor body 201 to the narrowing 315. The first portion 313 is shaped corresponding to a similar cross-sectional rectangular shape of the magnets 220 so that the magnets can be inserted in the slots 210.

The narrowing 315 can have substantially any cross sectional profile, but so that the narrowing forms a stop for the magnets so that the position of the magnets in a plane perpendicular to the rotor axis 202 is constrained by the sides of the magnet slots 210 within the first portion 313 and the narrowing 315.

As shown in FIG. 3, the narrowing 315 may be embodied by a protrusion where the material of the rotor body 201 bulges into the magnet slot from a side of the magnet slot, e.g. along a direction perpendicular to the longitudinal direction of the first portion.

The magnet slots 210 are arranged pairwise and arranged so that a first of the pair of magnet slots 370a is located on one side of a radius or radial line 341 of the rotor body and a second of the pair of magnet slots 370b is located on the other side of the radius 341. Longitudinal directions of the rectangular portions of the specific shape 310, or longitudinal directions of the first portions 313, of a pair of magnet slots 210 are angled towards the radius.

Thus, magnet slots 210 arranged mirrored on either side of a radial line forms a magnet slot pair 350. Magnets in a magnet slot pair 350 forms a single magnetic pole.

In an example, the angle between the longitudinal direction of the first slot 370a and the radius 341 and the angle between the longitudinal direction of the second slot 370b and the radius 341 are equal or substantially equal. In an example, the angle between the longitudinal direction of the first slot 370a and the second slot 370b is within the range from 40 to 50 degrees, such as 45 degrees.

In an example, the width of the first portion 313, i.e. the width of the rectangular portion of the slots 210, in a direction perpendicular to the longitudinal direction of the of the first portion 313, is approximately 1.9 mm. The length of the first portion 313, i.e. the length from the side of the magnet slot 210 closest to the outer edge of the rotor-body 201 or from the first radial position 311 to the narrowing 315 may be approximately 13 mm. Accordingly, the magnets 220 may have a length of approximately 13 mm and a width of approximately 1.9 mm, or slightly below these dimensions, so that they can be inserted in the slots 210.

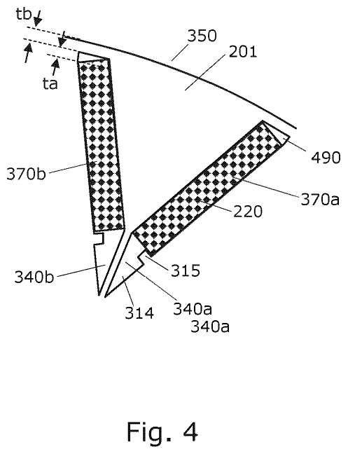

FIG. 4 shows a pair of magnet slots 210 with magnets 220 inserted. The magnet slots 210 are shaped so that an air gap 490 is formed between the side of each of the magnet slots being closest to the outer circumference of the rotor body and the side of each of the magnets 220 being closest to the outer circumference of the rotor body. The air gap may have a maximal radial extension ta in the range from 0.5 to 2 mm such as 1 mm.

Advantageously, the air gap 490 is shaped so that that a corner of the magnet 220 is in contact with the side of magnet slot 210 being closest to the outer circumference of the rotor body. This is achieved by forming the magnet slots 210 so that the resulting air gap has a triangular shape where the length of the shortest side of the triangle is equal or substantially equal to the maximal radial extension ta of the air gap 490.

Advantageously, by shaping the magnet slot 210 so that the air gap 490 becomes triangular with just one magnet corner in contact with the one side of the magnet slot closest to the outer circumference of the rotor body the material thickness tb, or bridge thickness, between the first radial position 311 and the outer circumference of the rotor body, which may in the range from 0.4 to 1 mm, e.g. approximately 0.8 mm, can be minimized.

Preferably, the side of the magnets 220 facing the outer circumference of the rotor body 201 abuts the side of the slots being closest to the outer circumference of the rotor body. Accordingly, one side of the magnets abuts the first radial position 311. Advantageously, since the magnets are arranged abutting the side of the slots 210 which faces the outer circumference of the rotor body 201, and no air gaps or substantially no air gaps are present between the magnets and the first radial position 311, the magnets are arranged as close to the outer circumference of the rotor body 201 as possible.

The protrusion of the narrowing may have a length of approximately 1 mm in the direction perpendicular to the longitudinal direction of the first portion and a width of approximately 1 mm perpendicular to its length.

Due to the narrowing 315, the magnets are separated from the second portion 314.

The second portion 314 extends from the narrowing 315 towards the rotor axis 202. The second portion 314 advantageously provides a flux barrier which due to the high reluctance imposed by air reduces the flux leakage of the magnets.

According to the example in FIG. 3, the second portion 314 is formed so that the cross-sectional circumference of the slot 210 tapers towards the rotor axis. Thus, in general the second portion 314 may have a triangular shape with an apex pointing towards the rotor axis or at least the center-area of the rotor body.

Specifically, as shown in FIG. 3, the shape of the edge of the second portion 314 of one of the magnet slots 370a of the pair of adjacent magnet slots comprises a first straight extension 340a which is parallel or substantially parallel with the radius 341 and arranged on one side of the radius at a distance therefrom. Similarly, the shape of the edge of the second portion 314 of the other magnet slot 370b of the pair of adjacent magnet slots comprises a second straight extension 340b which is parallel with the radius 341 and arranged on the opposite side of the radius 341 at a similar or same distance therefrom.

The magnets in the pair of the magnet slots form a magnetic pole. The magnets in a pair of the magnet slots are oriented with the same poles facing each other. Pairs the magnet slots are arranged along the circumference of the rotor body so that pairs of magnets form alternately north and south poles along the circumference of the rotor body.

In an example the rotor has 14 magnetic poles.

The stator of the permanent motor comprises cencentrated coils which are electrically energized to interact magnetically with the poles of the motor rotor. The number of magnetic poles of the stator may be the same as the number of magnetic poles of the rotor or the number of stator and rotor poles may be different. In an example the stator has 10 magnetic poles generated from cencentrated coils in 12 slots provided in the stator.

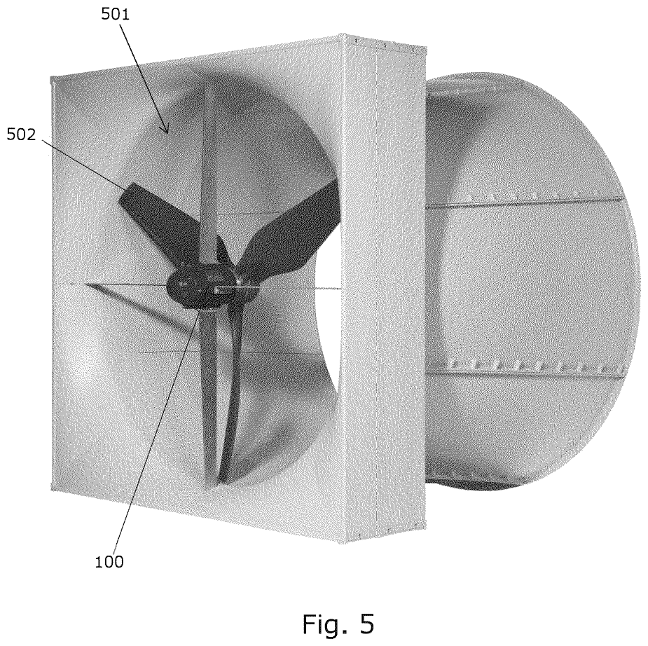

FIG. 5 shows a fan 501 which comprises an impeller 502 driven by the shaft of the motor 100. Since the motor is arranged in the air flow path of the fan, the diameter of the motor should preferably be as small as possible to minimize its effect on the generated air flow.

1. A motor rotor comprising
a cylindrical rotor body defining a rotor axis, wherein the cylindrical rotor body has a diameter in the range from 60 to 80 mm, and wherein a length of the rotor body is in the range from 90 to 150 mm,
a plurality of magnet slots extending axially through the rotor body, wherein
a circumference of each of the magnet slots, in a plane perpendicular to the rotor axis, has a specific shape, wherein
the specific shape extends from a first radial position proximal to an outer circumference of the rotor body to a second radial position distal to the outer circumference, and
the specific shape comprises a first portion, a second portion, and a narrowing between the first and second portions,
a plurality of magnets extending along the length of each of the magnet slots, where the magnets are positioned within the first portion and separated from the second portion by the narrowing, wherein
a pair of adjacent magnet slots are oriented so that lines connecting the first and second radial positions of the respective magnet slots taper towards a radius of the rotor body, and
the magnets in the pair of the magnet slots form a magnetic pole.

2. A motor rotor according to claim 1, wherein
the length of the rotor body is in the range from 105 to 130 mm.

3. A motor rotor according to claim 1, wherein an angle between the lines connecting the first and second radial positions of the pair of shapes of the magnet slots is in the range from 40 to 50 degrees such as around 45 degrees.

4. A motor rotor according to claim 1, where the second portion of the specific shape of the magnet slots tapers towards the rotor axis.

5. A motor rotor according to claim 1, wherein the second portion of the specific shape of one of the magnet slots of the pair of adjacent magnet slots comprises a straight extension parallel with a radial direction of the rotor body and parallel with a corresponding straight extension of the specific shape of the second portion of the other of the magnet slots of the pair of adjacent magnet slots.

6. A motor rotor according to claim 1, wherein an air gap is formed between a side of each of the magnets being closest to the outer circumference of the rotor body and a side of each of the magnet slots being closest to the outer circumference of the rotor body.

7. A motor rotor according to claim 1, wherein the number of poles is in the range from 10 to 18, such as in the range from 12 to 16, such as 14.

8. A permanent magnet motor comprising the motor rotor according to claim 1 and a stator.

9. A fan comprising:
a motor comprising a stator and the motor rotor according to claim 1,
an impeller, wherein a rotation axis of the impeller is coaxial with the rotor axis.

10. A fan according to claim 8, wherein the impeller has a diameter in the range from 600 to 1700 mm.
